(19) United States
(12) Patent Application Publication
(10) Pub. No.: US 2007/0157918 A1
(43) Pub. Date: Jul. 12, 2007

(54) Bar-b-que grill

(76) Inventor: Mark A. Becker, Alexandria, MN (US)

Correspondence Address: LAW OFFICE OF MICHAEL A. BLAKE, 112 BROAD STREET, MILFORD, CT, 06460, US

(21) Appl. No.: 11/329,568

(22) Filed: Jan. 11, 2006

(51) Int. Cl. A47J 37/00

(52) U.S. Cl. 126/25 R

(57) ABSTRACT

A bar-b-que grill comprising: a front wall; a first side wall in communication with the front wall; a rear wall in communication with the first side wall; a second side wall in communication with the front wall and the rear wall; a first slot located in the first side wall; a second slot located in the second side wall; a first U shaped rail in communication with the front wall, with an opening of the U facing towards the rear wall; a second U shaped rail in communication with the rear wall, with an opening of the U facing towards the front wall; at least one heat deflector plate, wherein the first and second U shaped rails are configured to allow the at least one heat deflector plate to slide along the first and second U shaped rails into and out of the bar-b-que grill via at least one of the first and second slots.

### TECHNICAL FIELD

The present invention relates to bar-b-que grills, and more particularly to a heat deflecting bar-b-que grill.

### BACKGROUND

A popular method of food preparation is bar-b-queing or grilling of the food in a cooking grill having a housing containing a food support positioned over a heat source. Additionally, the housing has a lid or cover for accessing or closing off the cooking area. Such cooking grills typically are fueled by gas (e.g. methane, propane, butane or the like) or by charcoal. Although flammable gas and charcoal are the prevalent fuels for such grills, liquid fuels may also be used.

The heat source in such cooking grills is generally configured in a horizontal plane, for example, as in a bed of charcoal in a charcoal grill, or the horizontal burners for a gas grill. The heat source provides heat which is directed or transferred to the cooking area. Foodstuffs located in the cooking area are then cooked by the heat. Outdoor cooking or barbeque grills are well known in the art. For gas cooking grills, the heat source typically includes a control assembly connecting a fuel source and the fuel burner, and can also include a means for concentrating or collecting the heat such as metal plates or ceramic briquettes (e.g. lava rocks), which are substantially in direct contact with the ignited fuel. In a charcoal fueled grill, the mass of the briquettes themselves act as heat collectors.

A principle means of directing the heat from the heat source to the cooking support is accomplished by having the cooking support directly above the heat source, in order to directly expose the food to heat from the heat source. The cooking support generally consists of a food grill or food grate which is typically a metal panel with open spaces in it, on top of which the foodstuff is placed to cook. The food support defines the cooking area of the cooking apparatus. However, in this configuration, any juices from the cooking foodstuff can drip through the spaces in the food grill and fall directly onto the heat source. The direct exposure of the drippings to the heat source can cause ignition of the drippings, resulting in flame flare-ups. The flare-ups cause uneven heating of the cooking area, scorching and the deposit of excess pyrolysis products on the cooking food.

Various examples of cooking grills and cooking grill attachments have attempted to overcome this problem, but none of them have been satisfactory. Therefore there is a need for a bar-b-que grill that prevents flare-ups, and other problems.

### SUMMARY

The disclosed invention relates to a bar-b-que grill comprising: a front wall; a first side wall in communication with the front wall; a rear wall in communication with the first side wall; a second side wall in communication with the front wall and the rear wall; a first slot located in the first side wall; a second slot located in the second side wall; a first U shaped rail in communication with the front wall, with an opening of the U facing towards the rear wall; a second U shaped rail in communication with the rear wall, with an opening of the U facing towards the front wall; at least one heat deflector plate, wherein the first and second U shaped rails are configured to allow the at least one heat deflector plate to slide along the first and second U shaped rails into and out of the bar-b-que grill via at least one of the first and second slots.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of a disclosed bar-b-que grill;

FIG. 2 is a top view of a cooking grate;

FIG. 3 is a perspective view of two charcoal trays;

FIG. 4 is top view of a charcoal tray frame;

FIG. 5 is a perspective view of the charcoal tray frame with the two charcoal trays installed;

FIG. 6 is a perspective view of the charcoal tray frame with the two charcoal trays installed and rotated;

FIG. 7 is close-up perspective view showing a hanger installed in a lip;

FIG. 8 is a top view of the U shaped rails and deflector plates; and

FIG. 9 is a top view of the U shaped rails and deflector plates, with the deflector plates extended out of the grill.

### DETAILED DESCRIPTION

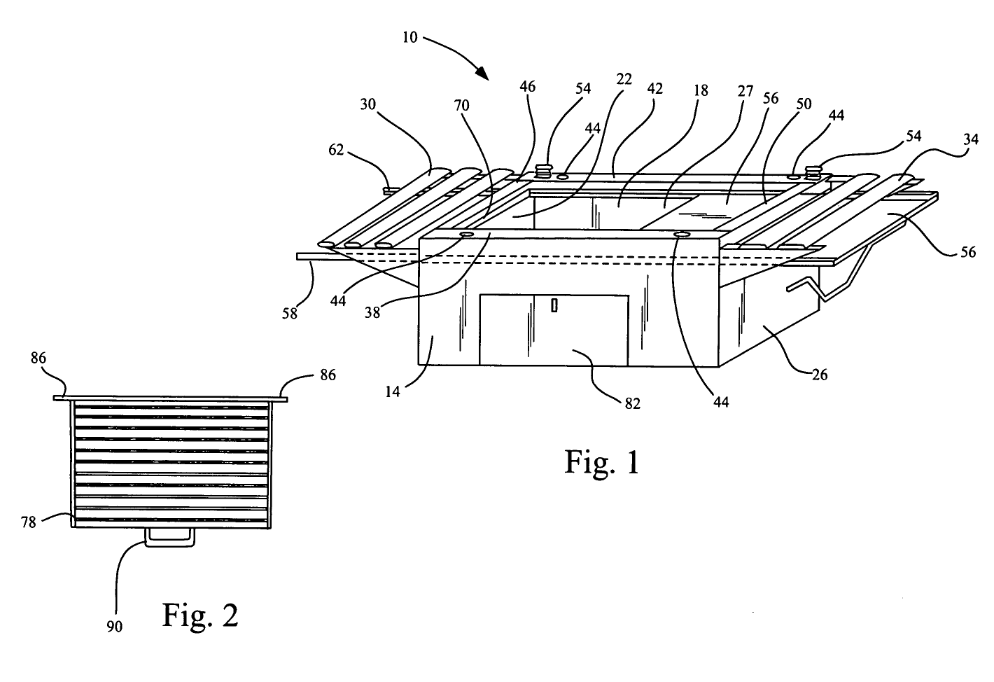

FIG. 1 shows a perspective view of a disclosed bar-b-que grill 10. The grill 10 has a front wall 14, rear wall 18, first side wall 22, and second side wall 26. The front wall 14, rear wall 18, first side wall 22, and second side wall 26 bound the interior 27 of the grill. The grill 10 also has a first side shelf 30 in communication with the first side wall 22, and a second side shelf 34 in communication with a second side wall 26. Located on the front wall 14 is a front wall lip 38, similarly, located on the rear wall 18 is a rear wall lip 42, located on the first sidewall 22 is a first sidewall lip 46, and located on the second sidewall 26 is a second sidewall lip 50. Located on the front wall lip 38 and rear wall lip 42 are a plurality of hanger slots 44. Located on the rear wall lip 42 are a plurality of spring clips 54. The spring clips 54 are configured to accept a cooking grate 78 (seen in FIG. 2), which when installed, the cooking grate 78 will rest on the lips 38, 46, 50. The cooking grate will be rotatable within the two spring clips 54, thus, in one orientation, the cooking grate will rest on the lips 38, 46, 50, and when raised, the cooking grate will rotate about an axis through the spring clips 54, thus providing access into the interior 27 of the grill. In another embodiment, there may be an additional a third spring clip located on the rear wall lip 42 and generally in between the first and second spring clips (not shown in this figure). A first cooking grate may be rotatably attached to the first and third spring clips and configured to rest on the first side wall lip 46, and front wall lip 38. A second cooking grate may be rotatably attached to the second and third spring clips and configured to rest on the second side wall lip 50, and front wall lip 38.

In communication with the front wall 14 is a first “U” shaped rail 58, with the opening of the “U” facing towards the rear wall 18. In communication with the rear wall 18 is a second “U” shaped rail 62, with the opening of the “U” facing towards the front wall 14. The first and second U shaped rails 58, 62 are configured to allow at least one heat deflector plate 56 to slide in and out of the interior 27 of the grill. The heat deflector plate 56 is shown about half way in the interior 27 of the grill 10 and about half way out the right side of the grill 10. The U-shaped rails 58, 62 extend generally past the first and second side shelves 30, 34. A slot 70 in the first side wall 22, and second side wall 26 allows the heat deflector plate 56 to slide in and out of the interior 27 of the grill 10 (the slot 70 is only visible in the first side wall 22 in this Figure). The slot may have a spring loaded door or weighted door, as known in the art, to keep the slot closed when the deflector plate is completely in or out of the interior 27 of the grill 10. The grill 10 is configured to have another heat deflector plate 56 slide along the rails 58, 62 on the left side of the grill. The heat deflector plate 56 has a bent rod handle 74, which allows a user to easily slide the plate 56 in and out of the grill without the handle impinging the shelves 30, 34. The grill is configured such that when both a heat deflector plate 56 on the left side of the grill and a heat deflector plate on the right side of the grill are fully inserted into the interior of grill, direct heat from the heat source (below the heat deflector plate) is blocked from the cooking grate. Located in the front wall 14 is an ash access door 82. If two deflector plates 56 are used with a grill 10, the deflector plates will be mirror images of each other, with one heat deflector plate 56 configured for use on the left side of the grill 10, and the other heat deflector plate 56 configured for use on the right side of the grill 10.

FIG. 2 shows a top view of the cooking grate 78. The cooking grate 78 has two members 86 configured to fit into the spring clips 54. The cooking grate 78 may also have a handle 90. The handle 90 may be configured to extend past a bar-b-que grill 10 lid (not shown), where by the handle remains relatively cool to the touch, and the grate may be rotated during and after cooking easily.

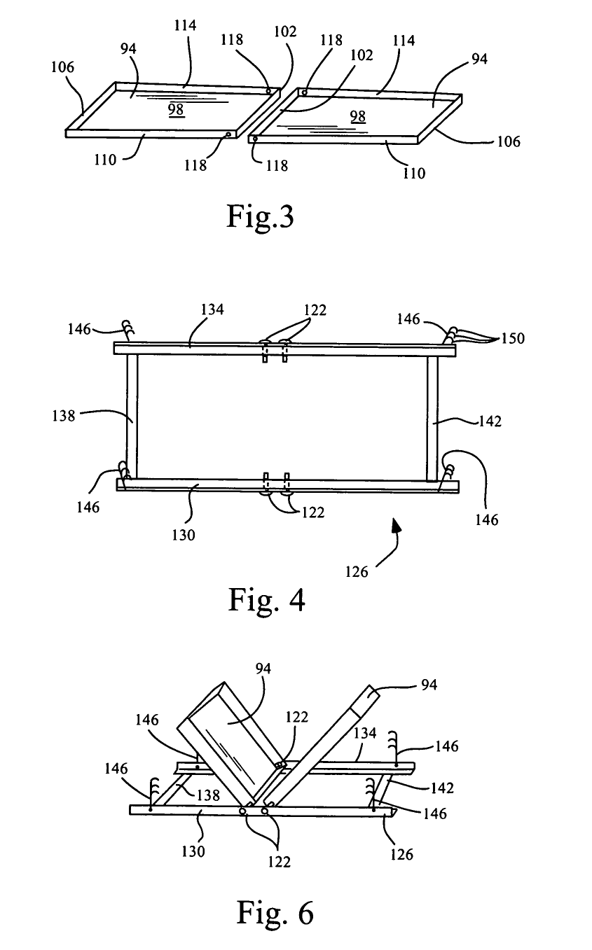

FIG. 3 shows two charcoal trays 94 that may be used with a grill if the heat source is charcoal. Each tray 94 has tray floor 98, tray inner wall 102, tray outer wall 106, tray front wall 110 and tray rear wall 114. The tray front walls 110 and tray rear walls 114 have openings 118 located near the inner wall 102 configured for communication with a pivot member 122 (shown in FIG. 4). The charcoal trays 94 may have ventilation holes punched into them (not shown for clarity).

FIG. 4 shows a charcoal tray frame 126 with a front member 130, rear member 134, and a first side member 138 in communication with the front member 130 and rear member 134, and a second side member 142 in communication with the front member 130 and rear member 134. The front member 130, and rear member 134 may be made from angle iron. The front member 130, and rear member 134 each have two pivot members 122, which may be, but are not limited to, pins. The front and rear members 130, 134 each have two hangers 146. Each of the hangers 146 have a plurality of hooking members 150.

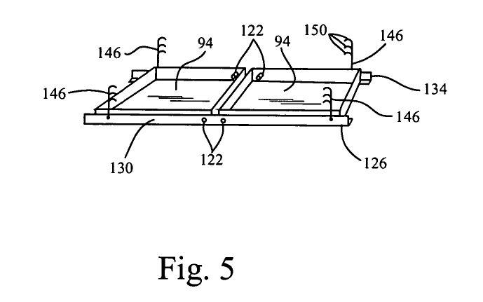

FIG. 5 shows the charcoal trays 94 installed in the charcoal tray frame 126. The charcoal trays 94 are rotatable about the pivot members 122, and rest along the bottom lip of the front member 130 and rear member 134.

FIG. 6 shows the charcoal trays 94 rotated up about the pivot members 122. Thus, when the trays 94 are lying generally flat in the frame 126, charcoal may be placed on the trays, and lit and used for cooking. When cooking is completely, and the grill has cooled down, the charcoal trays 94 may be struck against each other in order to dislodge ash on the trays, whereupon the ash will fall in the area between the two trays 94 for easy removal, e.g. if there is a ash collection bin located below the trays 94 in the grill 10. In other embodiments, inner walls 102 may be omitted.

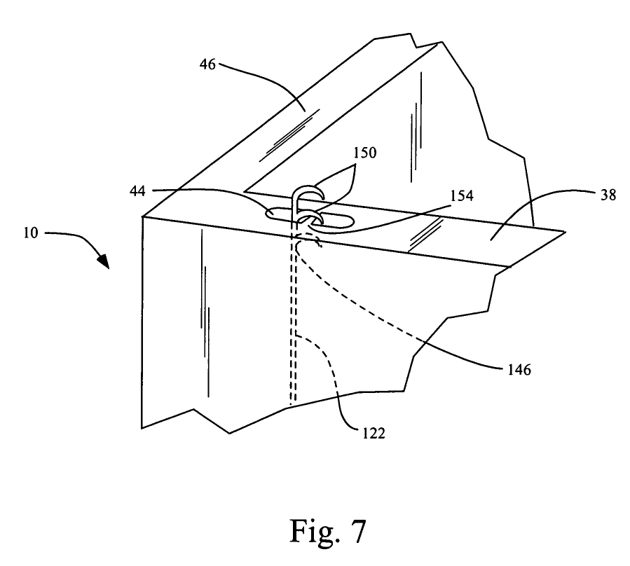

FIG. 7 shows a close-up partial view of a corner of the grill 10. In this view, the front wall lip 38, first side wall lip 46, one of the four (4) hanger slots 44 are shown. Each hanger slot 44 has a cross-member 154. The cross-member 154 is configured to allow a hooking member 150 to removeably attach to the cross-member 154. In this manner, the charcoal tray frame 126 and charcoal trays 94 may be installed to “hang” in a grill 10 Because each hanger 146 has a plurality of hooking members 150, the frame 126 may be raised or lowered within the grill 10, but using different hooking members 150 to attach to the hanger slot 44.

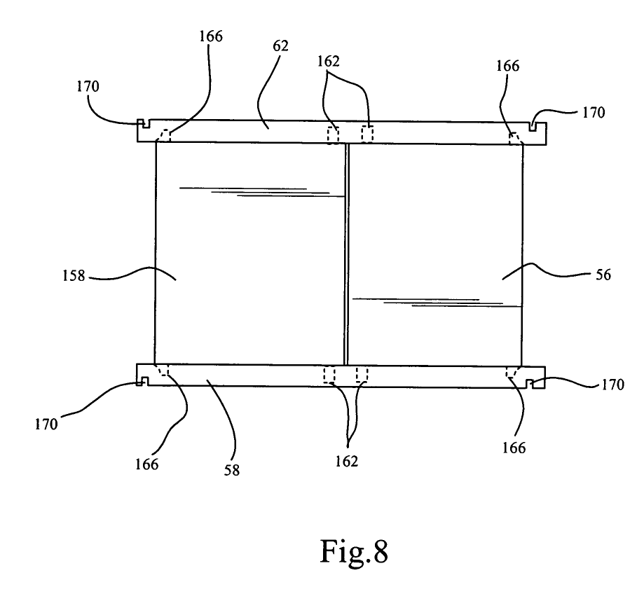

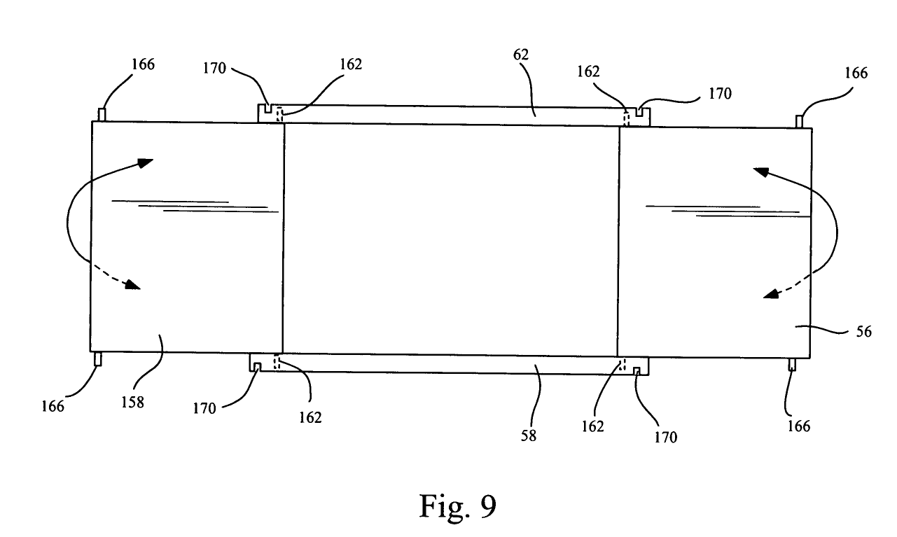

FIG. 8 is a top view of another embodiment of the deflector plates 56, 158 and u shaped rails 58, 62. In this embodiment, each of the deflector plates are held in place when inserted into the grill, by two sets of a pins, an inner set of pins 162, and an outer set of pins 166. The U shaped rails 58,62 each have two blocking members 170. The blocking members 170 are configured to allow the outer set of pins 166 to pass by the blocking members 170, while not allowing the inner set of pins 162 to pass by when the deflector plates 56, 158 are slid out of the grill. FIG. 9 shows both deflector plates 158, 56 slid out of the grill. Pins 166 were able to pass by the blocking members 170. However, pins 162 are not able to clear the blocking pin 170. Once pins 166 pass the blocking member as the deflector plate 56 or 158 is being slid out of the grill, the deflector plate is able to pivot about the pins 162, the arrows are meant to show the deflector plates ability to rotate into and out of the paper. In this manner, the deflector plates can be stored on the side of the grill and simply hang down by pins 162.

The disclosed grill 10 provides many advantages. The cooking grate is rotatable and removable, with a handle 90 that extends past the grill 10 lid to keep the handle relatively cool to the touch. The heat deflector plates 56 provide heat control and minimizes the chance of burning food. If food being grilled shows any signs of burning you can shield it from the heat source immediately with the heat deflector plates 56, instead of frantically shuffling food around. The heat deflector plates can eliminate smoke in your face typically caused from burning grease and food—no more burning eyes. The heat deflector plates 56 provide for indirect cooking—thus one can cook indirectly or directly on any part of the grill without wasting valuable space. The heat deflector plates 56 act as heat shields so that one can leisurely prepare food without having to use long utensils or gloves and remain in total comfort. Additionally, the rotatable charcoal trays 94 may simplify clean up of used charcoal/ash.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A bar-b-que grill comprising:
a front wall
a first side wall in communication with the front wall;
a rear wall in communication with the first side wall;
a second side wall in communication with the front wall and the rear wall;
a first slot located in the first side wall;
a second slot locate in the second side wall;
a first U shaped rail in communication with the front wall, with an opening of the U facing towards the rear wall;
a second U shaped rail in communication with the rear wall, with an opening of the U facing towards the front wall;
at least one heat deflector plate, wherein the first and second U shaped rails are configured to allow the at least one heat deflector plate to slide along the first and second U shaped rails into and out of the bar-b-que grill via at least one of the first and second slots.

2. The bar-b-que grill of claim 1, wherein the at least one heat deflector plate has a bent rod handle.

3. The bar-b-que grill of claim 1, further comprising:
a first side shelf in communication with the first side wall.

4. The bar-b-que grill of claim 1, further comprising:
a second side shelf in communication with the second side wall.

5. The bar-b-que grill of claim 1, further comprising:
an ash door located in the front wall.

6. The bar-b-que grill of claim 1, further comprising:
front wall lip in communication with the front wall;
a rear wall lip in communication with the rear wall;
first sidewall lip in communication with the first sidewall;
a second sidewall lip in communication with the second sidewall;
a first hanger slot located in the front wall lip and generally adjacent to the first sidewall;
a second hanger slot located in the front wall lip and generally adjacent to the second sidewall;
a third hanger slot located in the rear wall lip and generally adjacent to the first sidewall;
a fourth hanger slot located in the rear wall lip and generally adjacent to the second sidewall;
a charcoal tray frame with four hangers, the four hangers configured to hang from first, second, third and fourth hanger slots while suspending the charcoal tray frame within the bar-b-que grill;
two charcoal trays rotatably attached to the charcoal tray frame.

7. The bar-b-que grill of claim 1, further comprising:
at least one charcoal tray located in the interior of the bar-b-que grill and located below the at least one deflector plate when the deflector plate is installed in the grill.

8. The bar-b-que grill of claim 1, further comprising:
a first spring clip located on the rear wall lip and generally adjacent to the first side wall;
a second spring clip located on the rear wall lip and generally adjacent to the second side wall;
a cooking grate rotatably attached to the first and second spring clips, the cooking grate configured to rest on the first side wall lip, second side wall lip, and front wall lip.

9. The bar-b-que grill of claim 1, further comprising:
a first spring clip located on the rear wall lip and generally adjacent to the first side wall;
a second spring clip located on the rear wall lip and generally adjacent to the second side wall;
a third spring clip located on the rear wall lip and generally in between the first and second spring clips;
a first cooking grate rotatably attached to the first and third spring clips, the cooking grate configured to rest on the first side wall lip, and front wall lip;
a second cooking grate rotatably attached to the second and third spring clips, the cooking grate configured to rest on the second side wall lip, and front wall lip

10. The bar-b-que grill of claim 1, further comprising:
a first blocking member located within the first U shaped rail;
a second blocking member located within the second U shaped rail;
a first outer pin attached to the at least one heat deflector plate and configured to travel in the first U shaped rail, and further configured to clear the first blocking member;
a second outer pin attached to the at least one heat deflector plate and configured to travel in the second U shaped rail, and further configured to clear the second blocking member;
a first inner pin attached to the at least one heat deflector plate and configured to travel in the first U shaped rail, and further configured to impinge on the first blocking member;
a second inner pin attached to the at least one heat deflector plate and configured to travel in the second U shaped rail, and further configured to impinge on the second blocking member.
